(19) United States
(12) Patent Application Publication
(10) Pub. No.: US 2009/0309919 A1
(43) Pub. Date: Dec. 17, 2009

(54) INKJET RECORDING APPARATUS AND METHOD OF CONTROLLING THE SAME

(75) Inventor: Seiji Suzuki, Ebina-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/483,058

(22) Filed: Jun. 11, 2009

(30) Foreign Application Priority Data
Jun. 12, 2008 (JP) 2008-153994

(51) Int. Cl. B41J 2/165

(52) U.S. Cl. 347/32; 347/33

(57) ABSTRACT

An inkjet recording apparatus includes an encoder, a storage section, a difference calculating section, a threshold value determining section, a correction amount calculating section, and a controlling section. The storage section stores a capping target position and threshold value. The difference calculating section calculates a difference between a stopping position where a carriage is stopped for capping the recording head and a carriage position after passage of a predetermined time from when the carriage is stopped at the stopping position. The stopping position and carriage position are detected by the encoder. The threshold value determining section compares the threshold value and difference with each other. When the difference is greater than the threshold value, the correction amount calculating section calculates a correction amount of the capping target position. The controlling section moves the carriage to the capping target position corrected on the basis of the correction amount.

### BACKGROUND OF THE INVENTION

1. Field of the Invention

The present invention relates to an inkjet recording apparatus, and a method of controlling the inkjet recording apparatus.

2. Description of the Related Art

Hitherto, in general, in an inkjet recording apparatus, a mechanism for cleaning an ink recording head, carried by a carriage, is provided outside a recording area of the ink recording head. A slide cap method is known as one method of cleaning the ink recording head. In this method, the carriage carrying the recording head enters the cleaning mechanism, to cause a slider (holding a cap) to follow the carriage, so that the slider moves along a cam inclined surface. This causes various cleaning operations, such as capping, to be executed.

In the slide cap method, for performing selective suction operations of a plurality of mounted recording heads, a plurality of capping positions are required on the one hand, and there is a demand for reducing the width of the apparatus on the other. When positions near the cam inclined surface are set as the capping positions, the width of the apparatus can be made small. Here, a stopping position of the carriage is shifted by a reaction force from caps due to the number of recording heads, assembly precision, and parts position. Therefore, for normally performing the capping operations, it is necessary to correct the stopping position of the carriage.

Japanese Patent Laid-Open No. 2003-335011 discloses the following structure for correcting the stopping position of the carriage.

When the carriage is stopped at a target stopping position, the speed of the carriage is reduced to a controllable speed during a speed-reduction controlling operation for stopping the carriage at the target stopping position. At this time, a detecting unit compares a detected actual movement position of the carriage with a preset theoretical position. When the result of comparison shows that the actual movement position is in front of the theoretical position, the state of the carriage is shifted from a speed-reduction state to a temporary uniform speed state. After the state of the carriage is shifted to the uniform speed state, a carriage motor is controlled so that the state of the carriage is set again in the speed-reduction state. This causes the carriage to stop at the target position.

However, the above-described related structure has the following technical problems to be solved.

The structure in Japanese Patent Laid-Open No. 2003-335011 is one that controls the carriage motor when the carriage is moved for stopping the carriage at the target position.

In the slide cap method, it is necessary to provide a plurality of capping positions, and to provide capping positions at a horizontal portion near the cam inclined surface for reducing the width of an apparatus.

In this case, the stopping position of the carriage may become shifted due to parts precision and reaction force from the caps after the carriage is stopped. When the capping operations are carried out with the stopping position of the carriage being shifted, normal capping operations cannot be performed. Therefore, recording quality may be considerably reduced due to ink discharge failure caused by clogging of ink that is dried and thickened in and adhered to a discharge port with the passage of time.

### SUMMARY OF THE INVENTION

The present invention provides an inkjet recording apparatus and a method of controlling the inkjet recording apparatus, which can increase the reliability of capping operations.

According to an aspect of the present invention, there is provided an inkjet recording apparatus including a carriage carrying a recording head and capable of reciprocating, the recording head discharging ink from a discharge opening and performing recording on a recording material; a capping section configured to bring a cap into contact with the recording head by following a movement of the carriage and by moving the cap in a direction that crosses a direction in which the carriage reciprocates; a position detecting section configured to detect a position of the carriage; a difference calculating section configured to calculate a difference between a stopping position of the carriage where the carriage is stopped for capping the recording head and a position of the carriage after passage of a predetermined time from when the carriage is stopped at the stopping position, the stopping position and the position of the carriage after the passage of the predetermined time from when the carriage is stopped at the stopping position being detected by the position detecting section; a correcting section configured to correct the capping target position, when it is determined that the difference is greater than a predetermined value; and a controlling section configured to move the carriage to the capping target position corrected by the correcting section.

Further features of the present invention will become apparent from the following description of exemplary embodiments with reference to the attached drawings.

### BRIEF DESCRIPTION OF THE DRAWINGS

FIG. 1 is a perspective view of the structure of an inkjet recording apparatus according to an embodiment of the present invention.

FIG. 2 is a top perspective view of the structure of a cleaning mechanism and the structure of a carriage.

FIG. 3 is a top perspective view of the cleaning mechanism.

FIG. 4 is a perspective view of a driving transmission structure from a conveying roller to a pump.

FIG. 5 is a perspective view of a pump mechanism.

FIG. 6 is a bottom perspective view of a state in which a color recording head and a black recording head are carried by the carriage.

FIG. 7 is a top perspective view of the structure of a cap slider, which corresponds to the cleaning mechanism.

FIG. 8 is a bottom perspective view of the structure of the cap slider, which corresponds to the cleaning mechanism.

FIG. 9 is a top view of the structure of a lower portion of the cap slider, which corresponds to the cleaning mechanism.

FIG. 10 is a front schematic view showing the relationship between the position of the carriage and the position of the cleaning mechanism, when the cap slider is at a preliminary discharge position.

FIG. 11 is a front schematic view showing the relationship between the position of the carriage and the position of the cleaning mechanism, when the cap slider is at a wiping start position.

FIG. 12 is a front schematic view showing the relationship between the position of the carriage and the position of the cleaning mechanism, when suction of ink of the black ink recording head is performed.

FIG. 13 is a top schematic view showing the relationship between the position of the carriage and the position of the cleaning mechanism, when suction of ink of the black recording head and the color recording head is performed.

FIG. 14 is a top schematic view showing the relationship between the position of the carriage and the position of the cleaning mechanism, when the suction of ink of the black recording head is performed.

FIG. 15 is a top schematic view showing the relationship between the position of the carriage and the position of the cleaning mechanism, when the ink suction of the black recording head and the color recording head is performed.

FIG. 16 is a top schematic view showing the relationship between the position of the carriage and the position of the cleaning mechanism, when the cap slider is at a waiting position.

FIG. 17 is a rear schematic view showing the relationship between the position of the cap slider and the position of a blade trigger lever, when the cap slider is at the waiting position.

FIG. 18 is a top schematic view showing the relationship between the position of the carriage and the position of the cleaning mechanism, when the cap slider is at a wiping start position.

FIG. 19 is a rear schematic view showing the relationship between the position of the cap slider and the position of the blade trigger lever, when the cap slider is at the wiping start position.

FIG. 20 is a top schematic view showing the relationship between the position of the carriage and the position of the cleaning mechanism, when the cap slider is at a wiping end position.

FIG. 21 is a flowchart of capping operations in an embodiment of the present invention.

FIG. 22 is a control block diagram regarding the capping operations in the embodiment of the present invention.

### DESCRIPTION OF THE EMBODIMENTS

An embodiment according to the present invention will hereunder be described in detail with reference to the drawings.

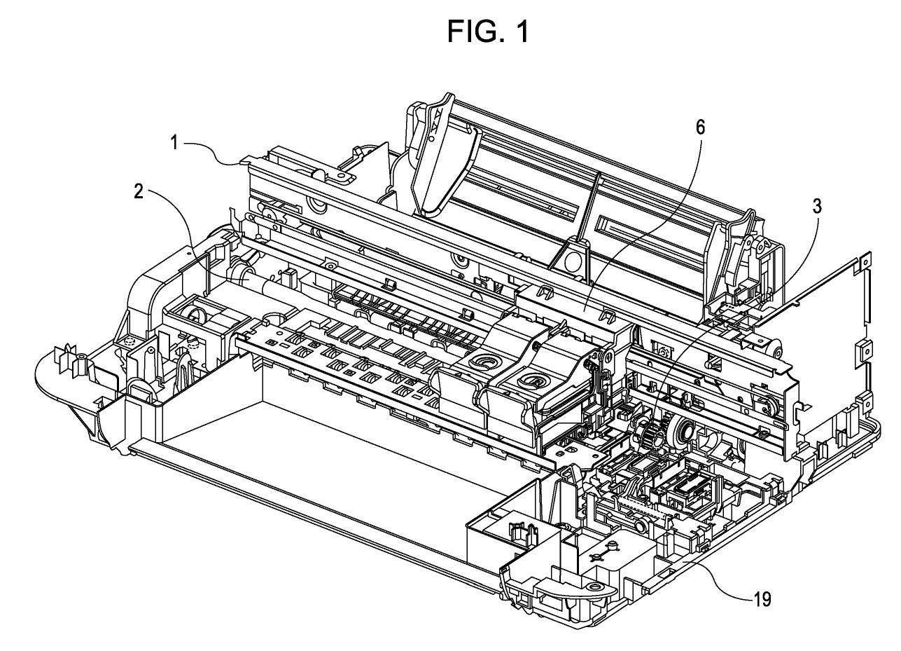

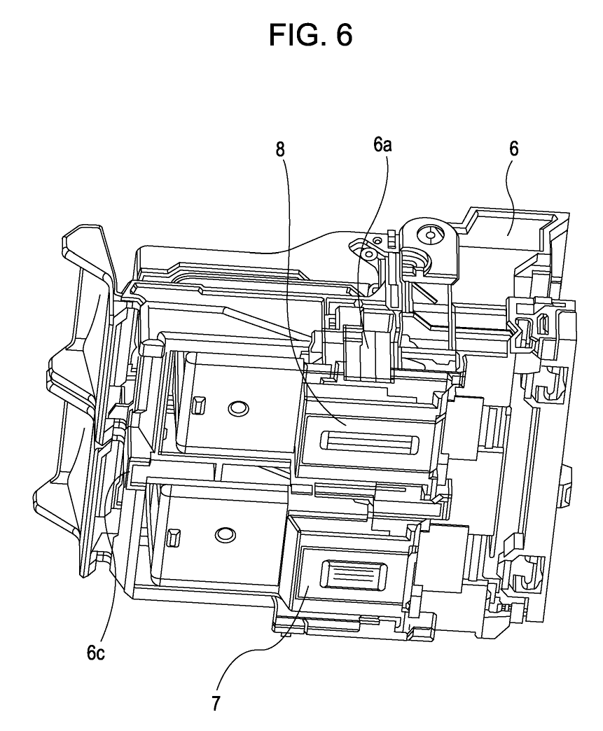

FIG. 1 is an external view of an inkjet recording apparatus according to the present invention. While a carriage 6 removably carries a color recording head 7 and a black recording head 8 (shown in FIG. 6) and repeatedly reciprocates with respect to a chassis 1 in a main scanning direction, ink is discharged to a recording material from discharge openings. A conveying roller 2 conveys a recording sheet in a sub-scanning direction (perpendicular to the main scanning direction) each time the main scanning of the carriage 6 ends. The inkjet recording apparatus performs recording on a recording sheet by repeating these operations.

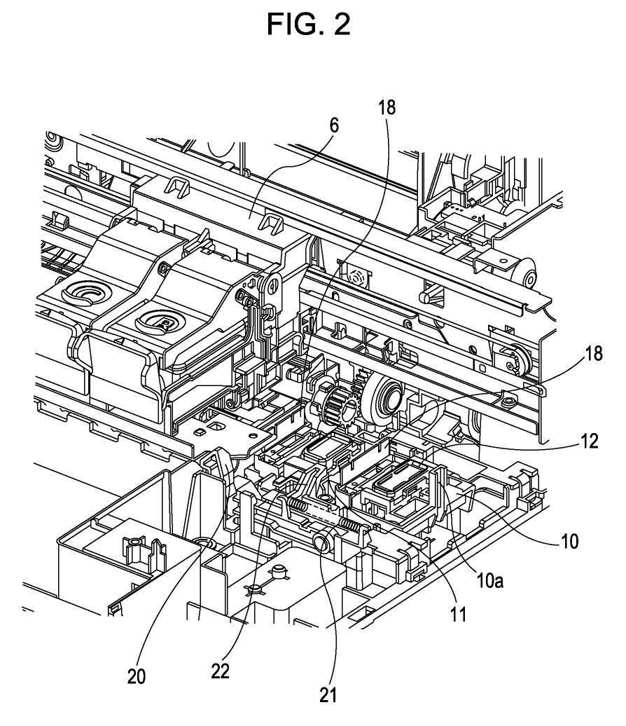

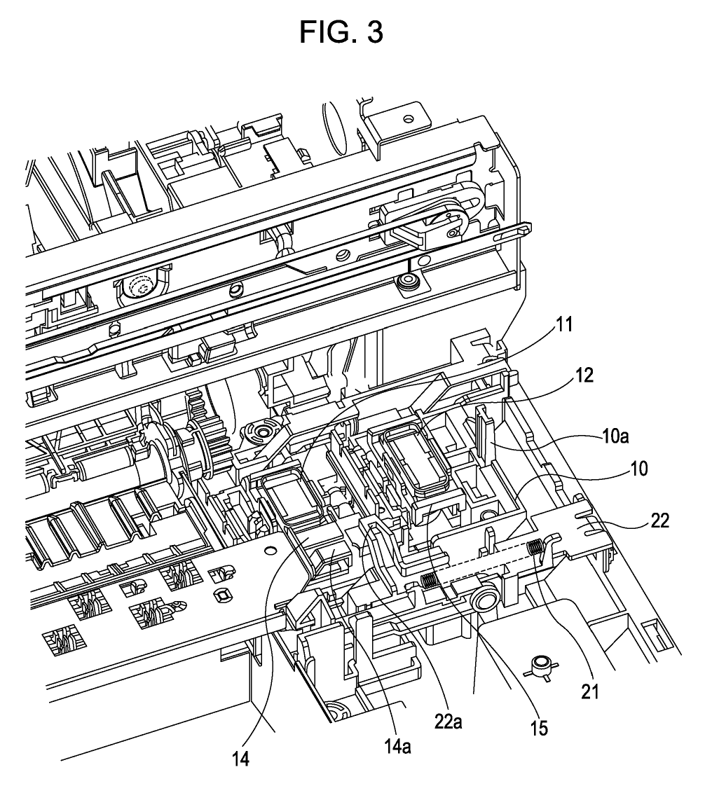

A cleaning mechanism is provided outside a recording area of the inkjet recording apparatus so as to oppose the carriage. FIGS. 2 and 3 are perspective schematic views of the cleaning mechanism.

The cleaning mechanism includes a capping unit and a wiping unit. The capping unit follows the movement of the carriage 6 in a reciprocating movement direction, and causes caps 11 and 12 to move in a direction crossing the reciprocating movement direction, so that capping, in which the caps 11 and 12 are brought into contact with the recording heads, is performed. The wiping unit wipes a surface of each recording head where the discharge opening is formed.

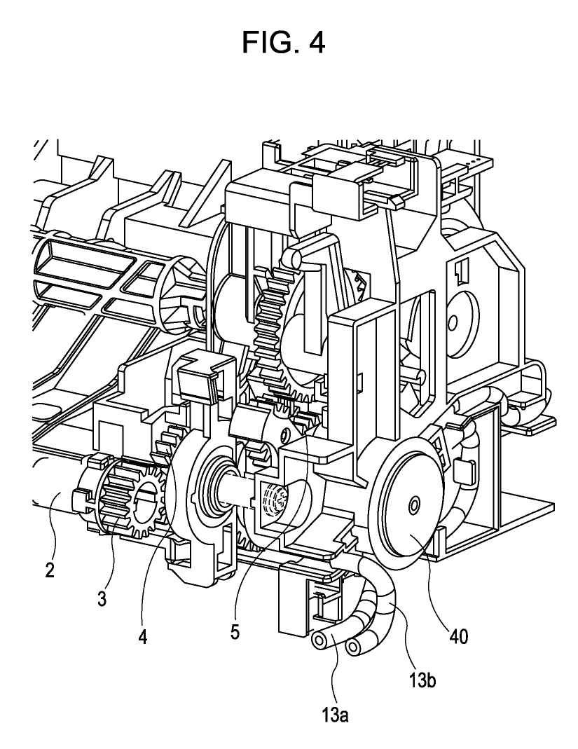

The caps 11 and 12 are held by a cap slider 10 through a cap holder 14 and a cap holder 15, respectively. When the cap slider 10 follows the movement of the carriage 6 and moves along a cam surface 19a of a base 19, and when the carriage 6 enters the cleaning mechanism, the capping is performed. Pump tubes 13a and 13b (see FIG. 4) for sucking ink by a pump mechanism are connected to the caps 11 and 12, respectively. The details of the wiping unit will be described below.

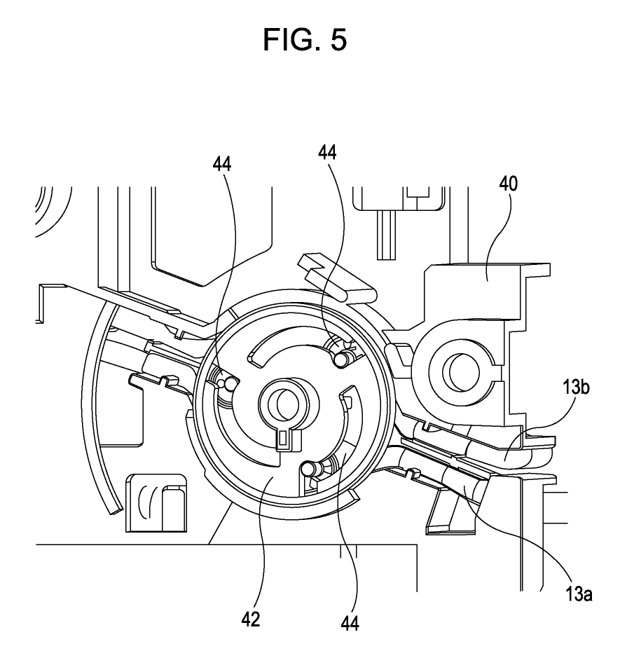

FIGS. 4 and 5 each show the pump mechanism according to the present invention. FIG. 4 is a perspective view of the pump mechanism as seen from a side thereof connected with a drive gear train, and FIG. 5 is an external perspective view of the pump mechanism. Pump rollers 44 are mounted to a pump holder 42. The pump rollers 44 are inserted in a pump base 40 so as to be rotatable in the pump base 40 with pump tubes 13a and 13b being interposed between the pump rollers 44 so as to extend along half a circumference of an inner wall of the pump base 40.

When the conveying roller 2 is driven in a reverse direction with the color recording head 7 and the black recording head 8 being capped, driving force is transmitted to the pump roller holder 42 through an output gear 3, an idler gear 4, and a pump driving gear 5. The pump rollers 44 move a cam, provided at the pump roller holder 42, so that the pump tubes 13a and 13b are pressed by the pump rollers 44 and the inner wall of the pump base 40. Further, when the reverse driving of the conveying roller 2 is continued, a negative pressure is generated in the pump tubes 13, thereby making it possible to suck ink from the ink discharge openings of the recording heads 7 and 8 through the respective caps 11 and 12.

When the sucking ends, and the negative pressure in the pump tubes is removed, the pump roller holder 42 is rotationally driven towards an opposite side (that is, the conveying roller is rotationally driven towards a forward-rotation side). Since the pump rollers 44 move so as to open the openings of the pressed pump tubes 13a and 13b, the negative pressure in the pump tubes can be removed.

FIG. 6 is a perspective view of the carriage 6 (carrying the color recording head 7 and the black recording head 8) as seen from an ink-discharge-port-surface side thereof. For cleaning the recording heads, various factors are involved in the conditions of ink suction and preliminary discharge. In the recording heads holding pigmented black ink, the pigmented ink tends to stick compared to when dye ink is used. Therefore, when a recording operation is performed after each recording head is capped for a certain period of time, a method that maintains good recording quality by executing the sucking operation prior to starting the recording operation, and by removing the thickened ink from the ink discharge openings is used.

Even if the recording heads holding dye ink are capped for a certain period of time, the ink is not easily thickened and does not easily stick, so that the ink sucking operation need not be carried out when they are ordinarily used. However, when, for reducing negative effects on the discharge of ink resulting from adhesion of ink mist onto the ink discharge surfaces, recording operations are continuously performed, if a predetermined amount of ink is discharged during the recording operations, a wiping operation as well as a preliminary discharge operation are performed, to stabilize recording quality. Here, the term “preliminary discharge” means discharge that is independent of image information. When, for some reason, ink discharge from each recording head is not stable, a sucking operation, etc., may be performed due to the judgment of a user of the recording apparatus.

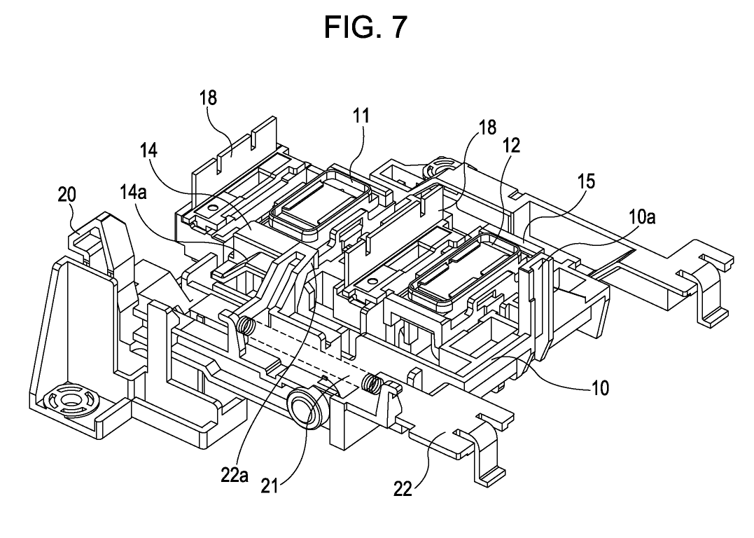

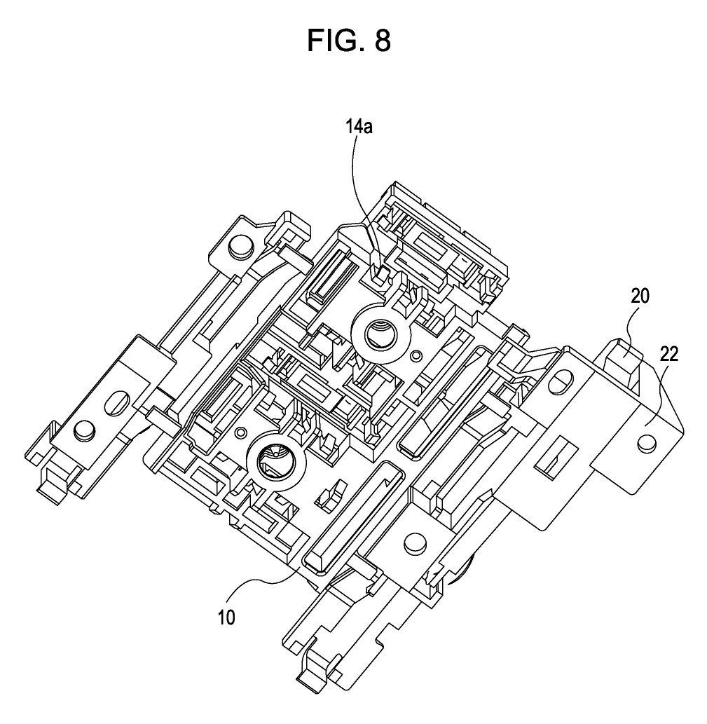

FIGS. 7 and 8 are perspective views each showing the details of the cleaning mechanism according to the present invention. The caps 11 and 12, which come into contact with the respective recording heads 7 and 8, are mounted to the respective cap holders 14 and 15. The cap holders 14 and 15 are held by the cap slider 10 with their heights being restricted so that the cap holders 14 and 15 are not removed even if a cap spring pressure acts thereupon by holding pawls. When the carriage 6 is positioned at a recording area side, the cap slider 10 is in a biased state and a statically determinate state so as to be positioned at the recording area side by a slider spring.

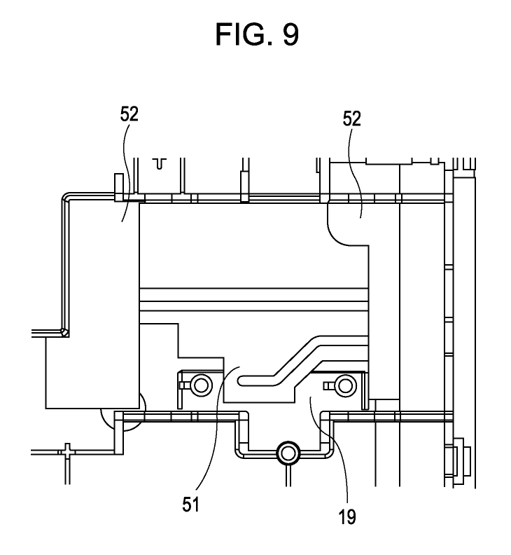

FIG. 9 is a top view of the structure of a lower portion of the cleaning mechanism. A thin plate member 51 having an elongated hole extending from a central portion to a end thereof is disposed at a base 19. Absorbing members 52 are disposed at respective ends of the thin plate member 51. Excess ink generated in the preliminary discharge or wiping operation is dripped onto the thin plate member 51 disposed at the base 19. The excess ink flows to the hole in the thin plate member 51, and is held in a gap between the base 19 and the thin plate member 51, spreads in the gap between the base 19 and the thin plate member 51, and is absorbed and held by the absorbing members 52 (disposed at the respective ends of the thin plate member 51).

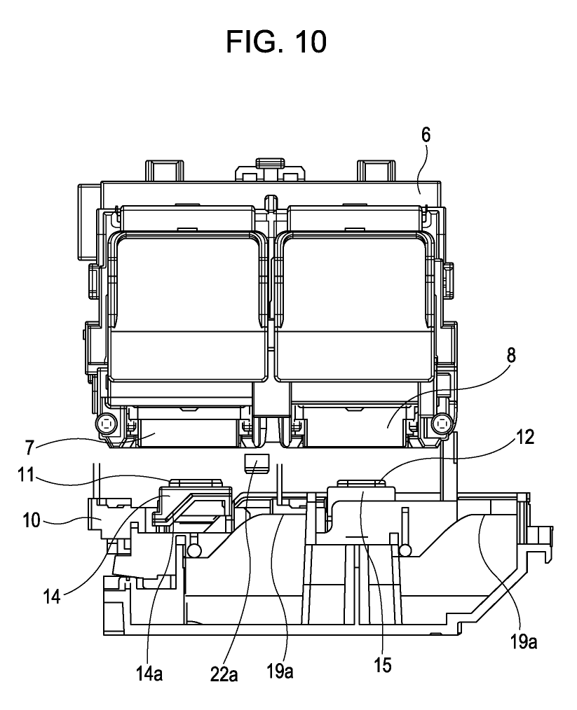

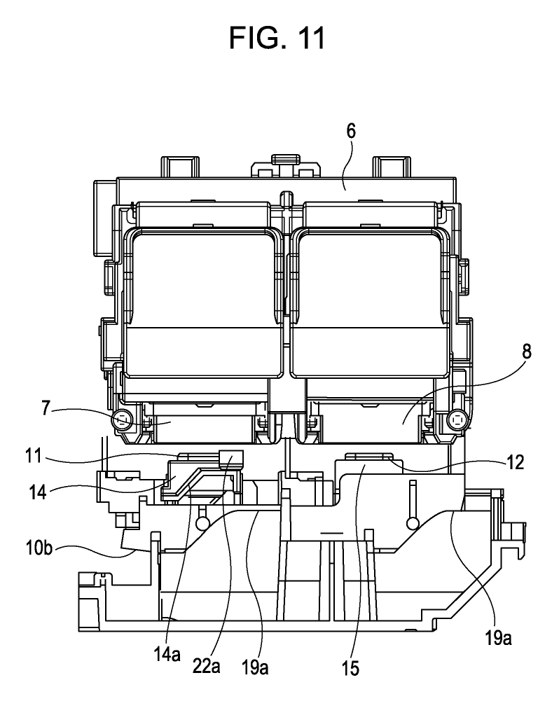

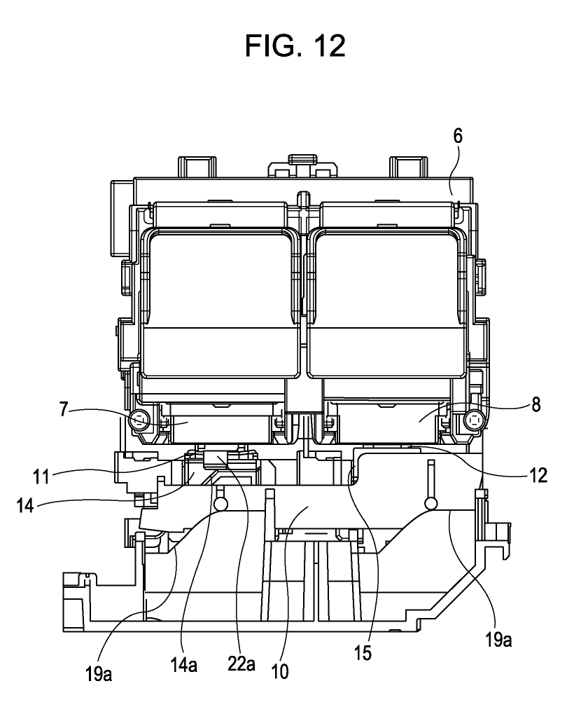

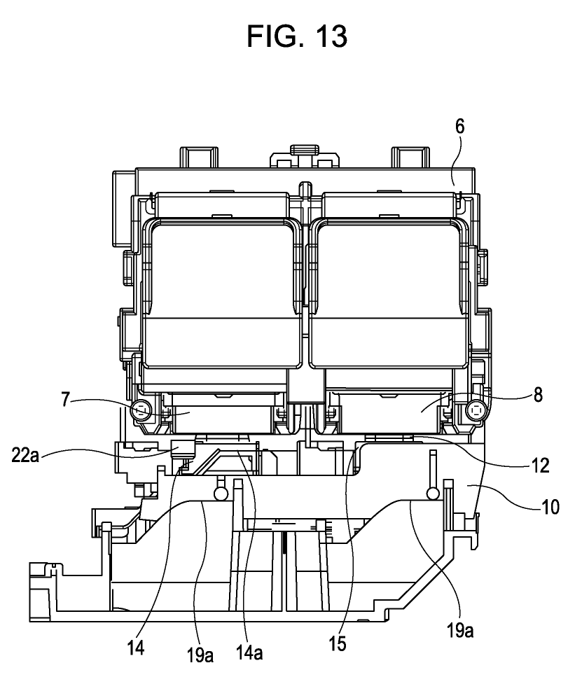

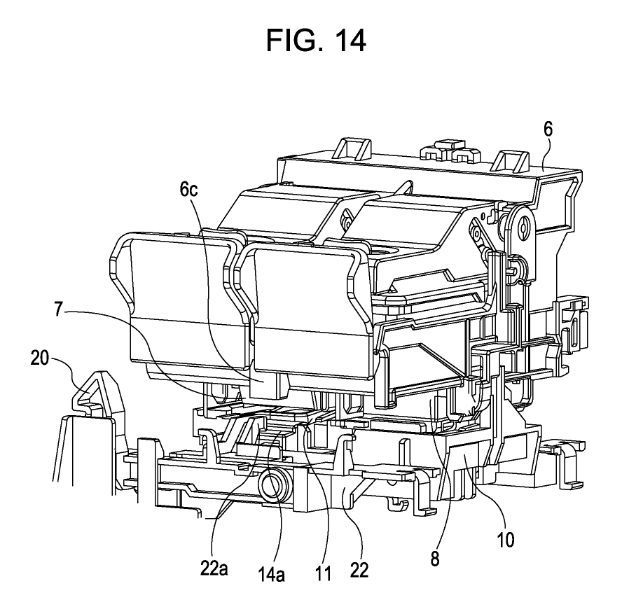

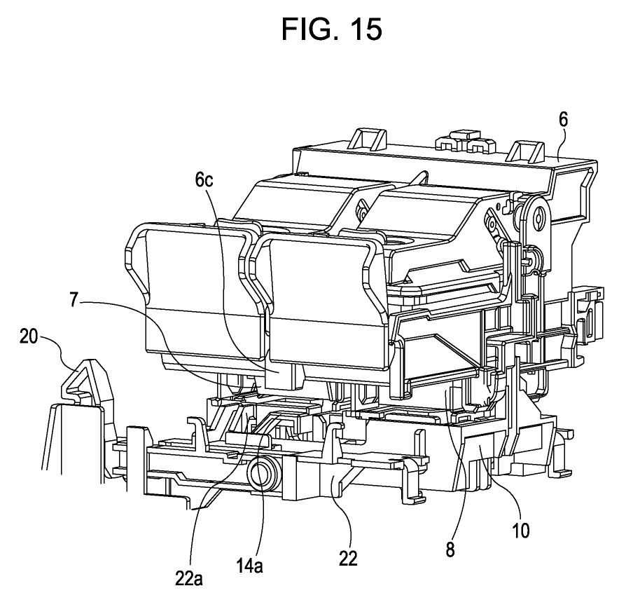

FIGS. 10 to 15 are front views showing the relationships between the positions of the carriage 6 and the slider 10, when the recording heads 7 and 8 are cleaned. FIG. 10 shows the relationship between the positions of the carriage 6, the cap slider 10, and the base cam surface 19a during preliminary discharge. FIG. 11 shows the relationship between the positions of the carriage 6, the cap slider 10, and the base cam surface 19a at a wiping start position. FIGS. 12 and 14 show the relationship between the positions of the carriage 6, the cap slider 10, and the base cam surface 19a, when ink of the black recording head 8 is sucked. FIGS. 13 and 15 show the relationship between the positions of the carriage 6, the cap slider 10, and the base cam surface 19a, when ink of the color recording head 7 and that of the black recording head 8 are sucked.

Here, the case in which the black recording head 8 is capped will be described. When the carriage 6 is moved towards the cleaning mechanism, as shown in FIG. 10, a carriage contact portion 6a and a cap slider contact portion 10a come into contact with each other. When, in this state, the carriage 6 is further moved towards the cleaning mechanism, as shown in FIG. 11, the cap slider 10 follows the movement of the carriage 6, and moves along the base cam surface 19a. This reduces the distance between the black recording head 8 and the cap 12. When the carriage 6 moves to a capping target position shown in FIG. 12, the black recording head 8 and the cap 12 contact each other, so that the black recording head 8 can be capped.

When, as shown in FIG. 11, the cap slider 10 moves along the inclined base cam surface 19a, a cap holder cam 14a and a cover-member contact portion 22a contact each other. When, in this state, the cap slider 10 further moves along the inclined base cam surface 19a, the cover-member contact portion 22a presses the cap holder cam 14a downward, so that the cap holder cam 14a rotates around a rotation shaft of the cap holder 14 as center.

At the positions shown in FIG. 12, the color recording head 7 and the cap 11 are opened at one end by pressing the cap holder cam 14a downward, so that a state of communication with the atmosphere is set.

Next, the capping of the color recording head 7 and the black recording head 8 will be described. From the capped state of the black recording head 8 shown in FIG. 12, the carriage 6 is moved to the position shown in FIG. 13. Since the cap holder cam 14a has an inclined surface, as shown in FIGS. 13 and 15, the cap holder cam 14a and the cover-member contact portion 22a are separated from each other. At this time, it is possible to cap the color recording head 7 by bringing the color recording head 7 and the cap 11 into contact with each other.

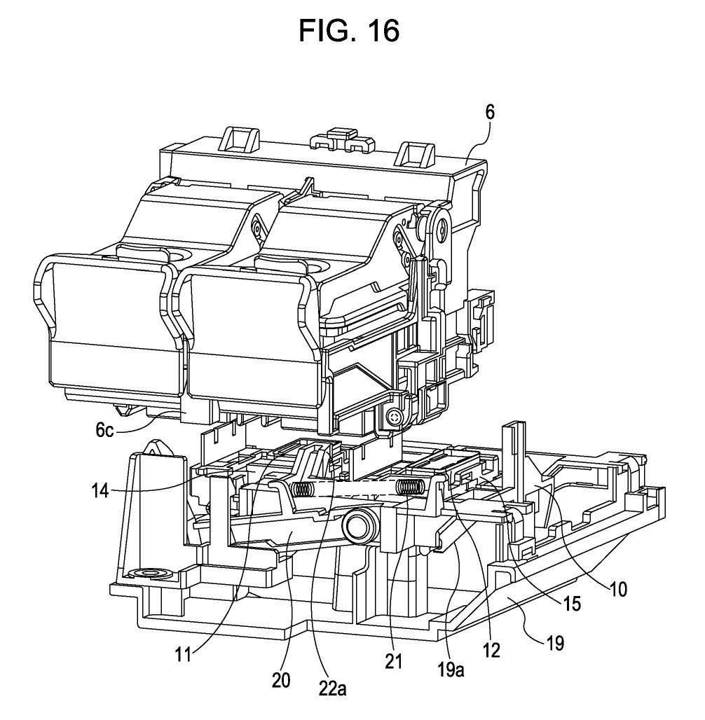

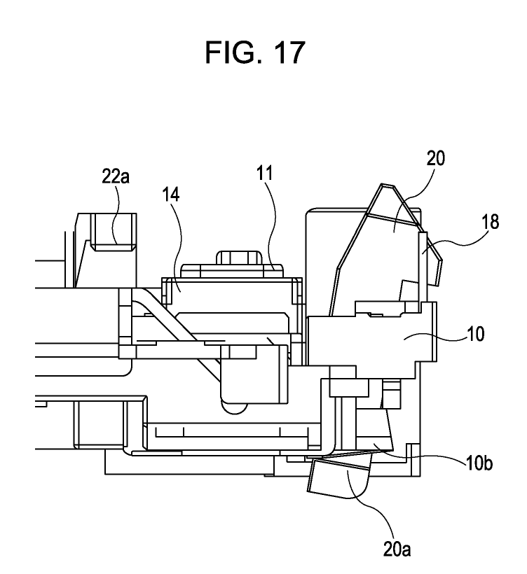

Next, wiping will be described with reference to FIGS. 16 to 20. FIG. 16 is a perspective view of the cleaning mechanism and the carriage 6, when the carriage 6 is outside an area of the cleaning mechanism. FIG. 17 is a rear view showing the relationship between the cap slider 10 and a blade trigger lever 20. By the action of a cap slider spring, the cap slider 10 abutting upon a side surface of the base 19 is in a statically determinate state. A blade trigger lever spring 21 causes a force acting in an upward rotational direction to act upon the blade trigger lever 20. At this time, a blade trigger lever contact portion 20a and a cap slider contact portion 10b contact each other, so that the position of the blade trigger lever 20 is restricted. As a result, the blade trigger lever 20 is held in the state shown in FIG. 17.

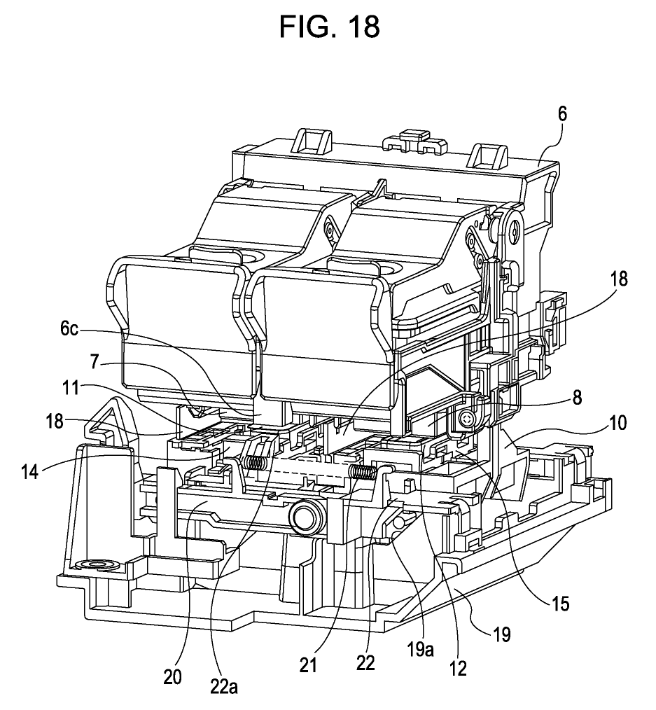

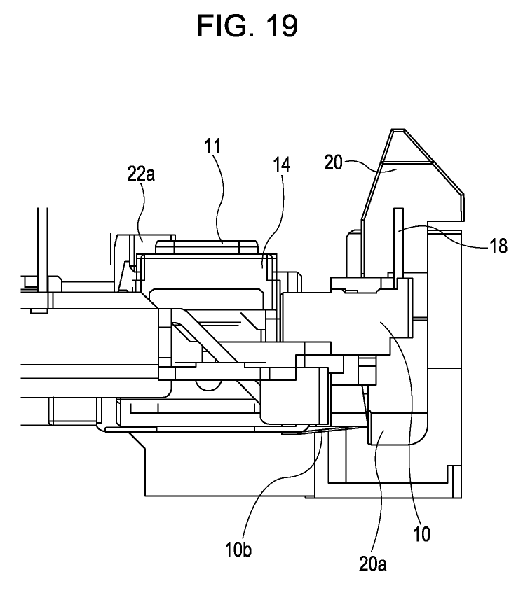

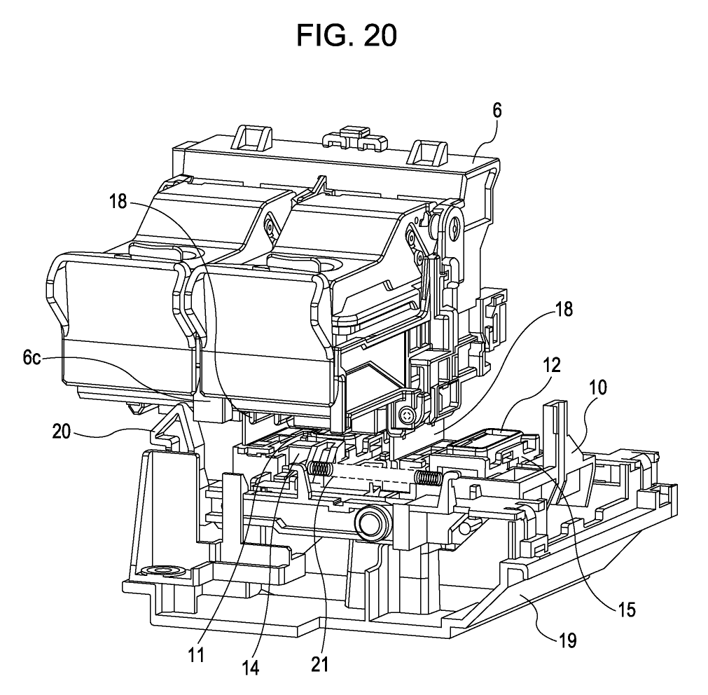

FIG. 18 is a perspective view of the cleaning mechanism and the carriage 6, when the carriage is at the wiping start position. FIG. 19 is a rear view showing the relationship between the cap slider 10 and the blade trigger lever 20. FIG. 20 is a perspective view of the cleaning mechanism and the carriage 6, when the carriage 6 is at a wiping end position.

The carriage 6 is moved towards the cleaning mechanism, and the cap slider 10 follows the movement of the carriage 6 and moves to the wiping start position shown in FIG. 18. The blade trigger lever contact portion 20a and the cap slider contact portion 10b separate from each other, so that the blade trigger lever 20 rotates until it strikes an abutting portion of a cover member 22.

Thereafter, when the carriage 6 moves in the reverse direction towards the recording area, the cap slider 10 is held in the state shown in FIG. 19 by the blade trigger lever 20. Therefore, the cap slider 10 stops following the movement of the carriage 6. Then, when the carriage 6 continues to move, a blade 18 (disposed at the cap slider 10) wipes the nozzle surface of each recording head.

Further, the carriage 6 continues moving towards the recording area up to the wiping end position shown in FIG. 20. At this time, a lever release portion 6c of the carriage 6 operates so as to push down an upper end of the blade trigger lever 20 in a downward rotational direction. Therefore, the cap slider 10 is no longer held by the blade trigger lever 20. This allows the cap slider 10 to return to its statically determinate position shown in FIG. 10.

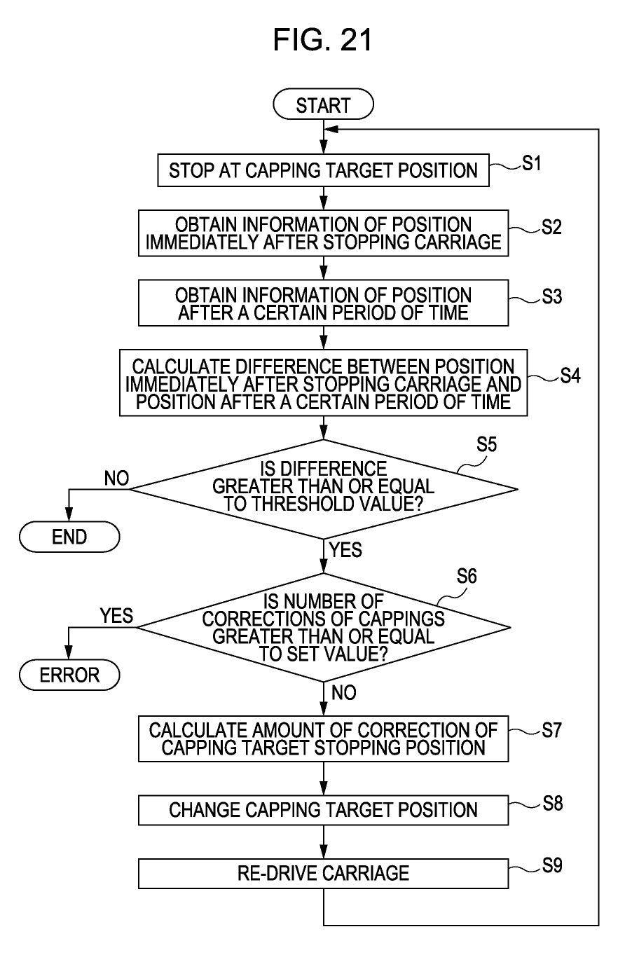

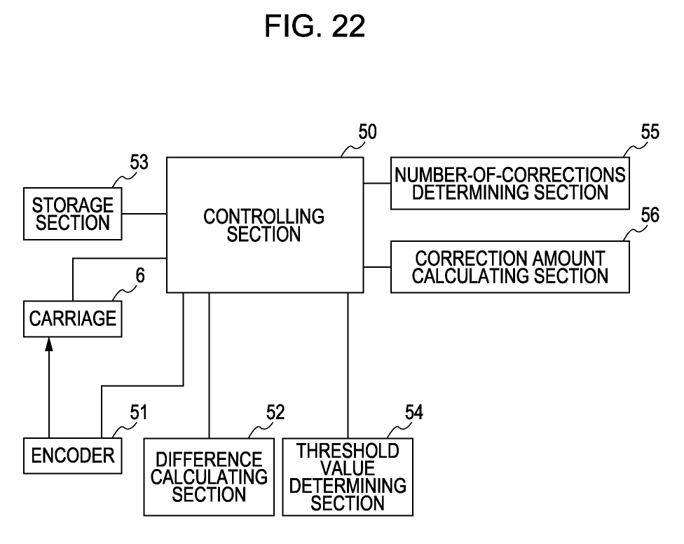

Next, the capping operations and the operations that are carried out when correcting the capping target position in the cleaning mechanism having the above-described structure will be described in detail with reference to FIGS. 21 and 22. FIG. 21 is a flowchart for correcting the capping target position. FIG. 22 is a control block diagram regarding the capping operations in the embodiment of the present invention.

As shown in FIG. 22, the inkjet recording apparatus includes a controlling section 50, an encoder 51, a difference calculating section 52, a storage section 53, a threshold value determining section 54, a number-of-corrections determining section 55, and a correction amount calculating section 56. The inkjet recording apparatus according to the embodiment performs the capping operations by the following steps using such a controlling system.

First, the controlling section 50 moves the carriage 6 up to a capping target position stored in the storage section 53, and stops the carriage 6 in Step S1.

Then, immediately after the carriage 6 is stopped at the capping target position, in Step S2, the encoder 51 (which is a position detecting section disposed at the carriage 6) obtains, as stopping position information, information regarding the position immediately after the carriage 6 is stopped. Here, the stopping position of the carriage 6 may become shifted due to, for example, reaction force generated during the capping or due to the number of recording heads or parts precision.

Then, in Step S3, the encoder 51 obtains information regarding the position of the carriage 6 after passage of a predetermined time from the stoppage of the carriage 6. This takes into consideration that fact that the carriage 6 that is stopped at the stopping position is shifted slightly from the stopping position, and is stably stopped at this slightly shifted position.

In Step S4, the difference calculating section 52 calculates the difference between the position immediately after stopping the carriage 6 (obtained in Step S2), and the position after the passage of the certain time (obtained in Step S3).

In Step S5, the threshold value determining section 54 determines whether or not the difference calculated in Step S4 is greater than or equal to a predetermined threshold value stored in the storage section 53. If, in Step S5, the difference is less than the threshold value (NO in Step S5), the controlling section 50 ends the process.

If, in Step S5, the difference is greater than or equal to the threshold value (YES in Step S5), the number-of-corrections determining section 55 determines whether or not the number of corrections of the capping target position is greater than or equal to a set number of corrections in Step S6. If, in Step S6, the number of corrections is greater than or equal to the set number of corrections (YES in Step S6), the controlling section 50 determines that an error has occurred, and ends the process.

If, in Step S6, the number of corrections is less than the set number of corrections (NO in Step S6), the correction amount calculating section 56 calculates the amount of correction of the capping target position in Step S7.

The next capping target position is determined on the basis of the correction amount calculated in Step S7, so that, in Step S8, the capping target position is changed to the corrected capping target position. When the capping target position is corrected, it is possible to store the corrected capping target position in the storage section 53, and to set subsequent capping target positions as corrected capping target positions. A plurality of target positions are stored in the storage section 53.

The capping target position may be corrected on the basis of a certain interval (for example, on the basis of the number of recording sheets, the number of carriage scanning operations, or time) in addition to the difference in the carriage stopping position. This makes it possible to make the capping operations more reliable even if changes occur in the environment or variations in load occur due to endurance.

Next, re-driving of the carriage, which is the operation in Step S9, will be described. The controlling section 50 reverses the direction of movement of the carriage 6 from the stopping position of the carriage 6 shown in FIG. 12, and temporarily moves the carriage 6 to a position that is outside the area of the cleaning mechanism. The controlling section 50 moves the carriage 6 into the area of the cleaning mechanism again and to the corrected capping target position, so that it repeats the operations from Step S1 to Step S9. When the corrected capping target position is a position that is further shifted from the wiping start position, the controlling section 50 may temporarily move the carriage 6 to the wiping end position. In addition, thereafter, the controlling section 50 may move the carriage 6 to the corrected capping target position, and repeat the operations from Step S1 to Step S9.

According to the embodiment, when the stopping position of the carriage 6 is shifted from the capping target position, the capping target position is corrected to re-drive the carriage 6 and to move the carriage 6 to the corrected capping target position. This makes it possible to make the capping operations more reliable. In addition, when the capping operations are made more reliable, a plurality of capping positions can be provided in the slide cap method, and an increase in the width of the apparatus can be restricted.

While the present invention has been described with reference to exemplary embodiments, it is to be understood that the invention is not limited to the disclosed exemplary embodiments. The scope of the following claims is to be accorded the broadest interpretation so as to encompass all modifications and equivalent structures and functions.

This application claims the benefit of Japanese Patent Application No. 2008-153994 filed Jun. 12, 2008, which is hereby incorporated by reference herein in its entirety.

What is claimed is:

1. An inkjet recording apparatus comprising:
a carriage carrying a recording head and capable of reciprocating, the recording head discharging ink from a discharge opening and performing recording on a recording material;
a capping section configured to bring a cap into contact with the recording head by following a movement of the carriage and by moving the cap in a direction that crosses a direction in which the carriage reciprocates;
a position detecting section configured to detect a position of the carriage;
a storage section configured to store a capping target position corresponding to a stopping position where the carriage is stopped for capping the recording head;
a difference calculating section configured to calculate a difference between the stopping position of the carriage where the carriage is stopped for capping the recording head and a position of the carriage after passage of a predetermined time from when the carriage is stopped at the stopping position, the stopping position and the position of the carriage after the passage of the predetermined time from when the carriage is stopped at the stopping position being detected by the position detecting section;
a correcting section configured to correct the capping target position, when it is determined that the difference is greater than a predetermined value; and
a controlling section configured to move the carriage to the capping target position corrected by the correcting section.

2. The inkjet recording apparatus according to claim 1, further comprising a wiping unit configured to wipe a surface of the recording head where the discharge opening is provided,
wherein, when the controlling section moves the carriage to the capping target position corrected by the correcting section, the controlling section moves the carriage to the capping target position after causing the carriage to move past a position opposing the wiping unit.

3. The inkjet recording apparatus according to claim 2, wherein the controlling section moves the carriage to the capping target position after moving the carriage to a position where the wiping ends.

4. The inkjet recording apparatus according to claim 1, wherein the controlling section causes the storage section to store the capping target position corrected by the correcting section.

5. The inkjet recording apparatus according to claim 1, wherein the storage section stores a plurality of the capping target positions.

6. A method of controlling an inkjet recording apparatus including a carriage and a capping section, the carriage carrying a recording head and capable of reciprocating, the recording head discharging ink from a discharge opening and performing recording on a recording material, the capping section being configured to bring a cap into contact with the recording head by following a movement of the carriage and by moving the cap in a direction that crosses a direction in which the carriage reciprocates, the method comprising:
detecting a position of the carriage;
calculating a difference between a stopping position of the carriage where the carriage is stopped for capping the recording head and a position of the carriage after passage of a predetermined time from when the carriage is stopped at the stopping position;
correcting a capping target position stored in a storage section, when it is determined that the difference is greater than a predetermined value; and
moving the carriage to the corrected capping target position.

7. The method according to claim 6, wherein, when moving the carriage to the corrected capping target position, the carriage is moved to the capping target position after moving the carriage past a position opposing a wiping unit, the wiping unit wiping a surface of the recording head where the discharge opening is provided.

8. The method according to claim 7, wherein the carriage is moved to the capping target position after moving the carriage to a position where the wiping ends.

9. The method according to claim 6, further comprising storing the corrected capping target position in the storage section.

10. The method according to claim 6, wherein a plurality of the capping target positions are stored in the storage section.
